(19) United States
(12) Patent Application Publication
(10) Pub. No.: US 2007/0116042 A1
(43) Pub. Date: May 24, 2007

(54) Power extension apparatus having local area network switching function

(76) Inventors: Chiang-Ta Lee, Renyi Township (TW); Ming-Cheng Luo, Taipei (TW)

Correspondence Address: LIN & ASSOCIATES INTELLECTUAL PROPERTY, P.O. BOX 2339, SARATOGA, CA, 95070-0339, US

(21) Appl. No.: 11/283,452

(22) Filed: Nov. 18, 2005

(51) Int. Cl. H04J 3/16

(52) U.S. Cl. 370/466

(57) ABSTRACT

A power extension apparatus for local area networking is disclosed. The power extension apparatus has an array of power sockets and network interface ports on an extension cable, where the power sockets are to connect two or more computing devices to a power line wiring, and the network interface ports are to establish data communications among the computing devices being connected to form a local area network. The local area network can be further linked to other networks also being connected to the power line wiring, which may be in the same building, so long as the data communication is compliant with HomePlug and other similar standards. These computing devices being connected through the power line wiring are able to exchange audio, video, text, and control data bi-directionally.

### BACKGROUND OF THE INVENTION

1. Field of the Invention

The present invention relates to a local area network using existing power line wiring, in particular to a power extension apparatus having a network switching function for the power-line based local area network.

2. The Related Art

Riding on the tremendous growth of PCs, many computer users have second computer and more than one peripheral device back at home for creating a home network or local area network. For example, a desktop computer, a notebook computer, a scanner, and a printer are all connected by some means to exchange data and share a common router to the Internet.

The more common local area networks are Ethernet and wireless LAN (802.11x). However, after a decade of development, there are other options available, such as HomePNA, HomePlug, etc.

HomePNA is a networking standard basing on the existing telephone lines, while HomePlug is another networking standard that utilizes the existing power line wiring to connect to multiple home PCs as shown in FIG. 1.

The power line network has a number of advantages. First, there is no need to lay down a separate network. Second, the power line network is not as easily affected by interference as in a wireless network. Third, as the power line network is separated from the outside wiring by the household's wattage meter and there is therefore no data security concern.

Homeplug, a trademark of the HomePlug Powerline Alliance, is an industry-standard method for transmitting and receiving data via the power line, which can be audio, video, text, control signals, etc.

Referring to FIG. 1, showing a typical architecture of the HomePlug network, where the computing devices 10, 11 are connected to the power line wiring 30 through special adaptors 20 and wall outlets 31. Each special adaptor 20 has a conventional power plug on one end for plugging into the wall outlet 31 or an ordinary power extension cord 32, and the cable connection between a computing device 10/11 and an adaptor 20 is either an universal serial bus (USB) cable or a RJ-45 cable. The computing devices 10, 11 being connected through the power line wiring 30 form a HomePlug local area network as such.

Each special adaptor 20 is built in with a HomePlug module for connecting computing devices to the HomePlug network. The HomePlug network could be further linked with other local area networks (such as the Ethernet 40), and could be connected to the Internet 60 via ADSL/cable modems 50.

However, there are several limitations for using the special adaptors 20. For example, the bulky size and shape of the special adaptor 20 would have trouble in plugging into or unplugging from one of the power sockets adjacent to each other and crowded with various cables.

Each special adaptor 20 usually provides only one network interface port. When more than one computing devices are to be linked to create a HomePlug network, several special adaptors are needed to fulfill the purpose, but then there might not be enough wall outlets. The alternative is to connect these PCs through a network hub or switch 70.

In these aspects, the power extension apparatus for HomePlug networking according to the present invention substantially reduces or obviates the limitations and disadvantages of the prior art.

### SUMMARY OF THE INVENTION

The primary object of the invention is to provide a power extension apparatus for a power-line based local area network that acts as a network hub or switch.

The secondary object of the invention is to provide a power extension apparatus that supports the HomePlug standard or other similar communication standards using existing power line wiring.

To achieve the above-mentioned objects, the present invention provides a power extension apparatus that physically resembles a power extension cord, having an extension cable of appropriate length with a power plug on one end, and a casing on the other end, through which two or more computing devices are connected to form a power-line network.

In accordance with the present invention, there is an array of power sockets and network interface ports on the surface panel of the casing. This power extension apparatus serves dual functions: one is to provide power distribution to one or more computing devices connected to the power sockets, and another one is to provide data communications among the computing devices being connected to network interface ports.

In accordance with the present invention, the power extension apparatus built in with the HomePlug module allows two or more computing devices being connected to an existing power line wiring in a building to form a local area netvork in compliance with an appropriate data communication protocol.

In accordance with the present invention, the power extension apparatus built in with the HomePlug module allows a local area network to be linked to other computing devices over the existing power line wiring in compliance with an appropriate data communication protocol.

These along with other features of novelty which characterize the invention, are pointed out with particularity in the claims annexed to and forming a part of this disclosure. For a better understanding of the invention, the operating advantages and the specific objectives attained by its uses, references should be made to the accompanying drawings and descriptive matter illustrated in preferred embodiments of the invention.

### BRIEF DESCRIPTION OF THE DRAWINGS

FIG. 1 is a diagram of a network architecture basing on the HomePlug technology;

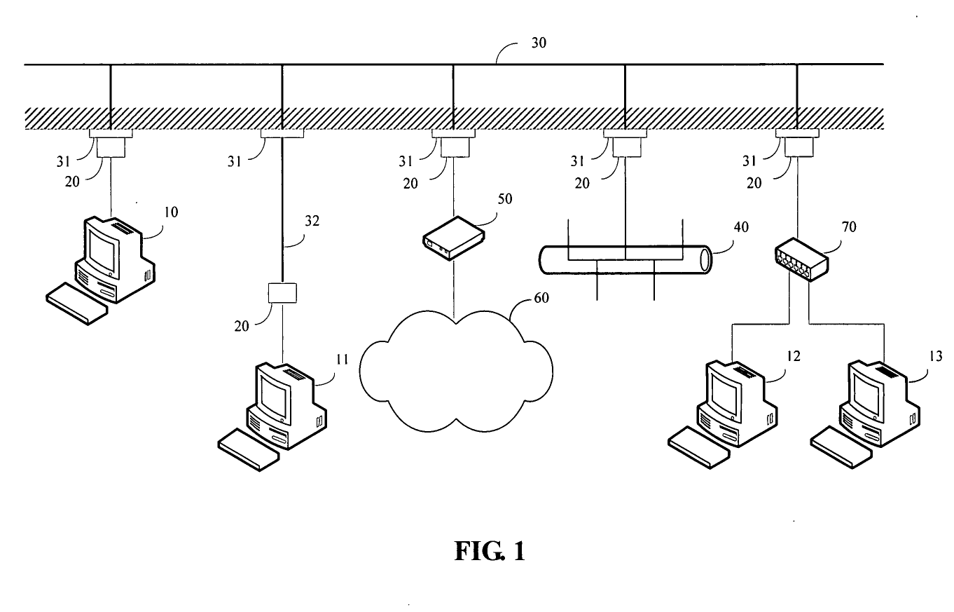

FIG. 2 is a top view of the structure of the power extension apparatus in accordance with one preferred embodiment of the invention;

FIG. 3 is a block diagram of the hardware architecture of the power extension apparatus.

### DETAILED DESCRIPTION OF THE PREFERRED EMBODIMENT

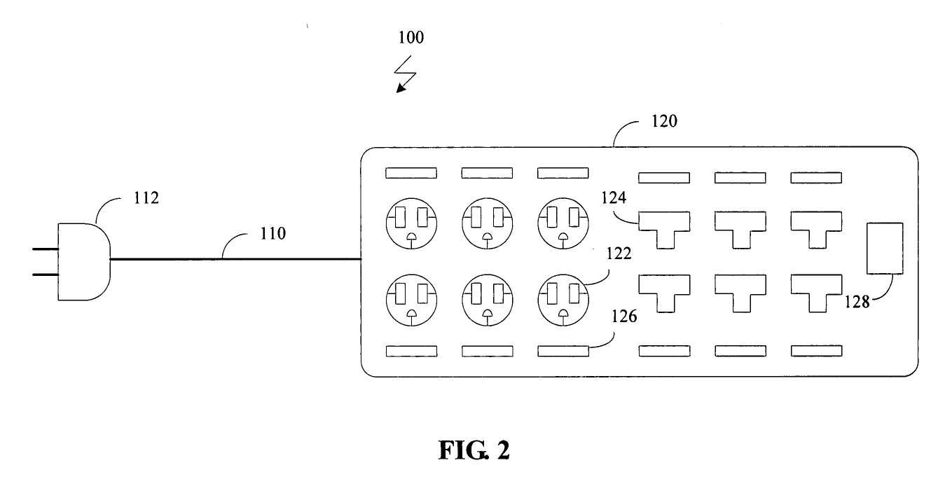

The power extension apparatus 100 as shown in FIG. 2 has an extension cable 110 of appropriate length, one end of which has a power plug 112 for plugging into a wall outlet or a power socket of other power source.

One end of the extension cable 110 is connected with a casing 120, which has an array of power sockets 122 on one side and an array of network interface ports 124 on the other side. The power sockets 122 provide power distribution to one or more computing devices being connected thereon. The network interface port 124 is a standard RJ-45 connector, which is to be connected to a computing device using the standard RJ-45 Ethernet cable.

The power extension apparatus 100 is able to support different power distribution specifications depending on the local requirements. In the present example, the power extension apparatus 100 is connected to power lines having 110V AC/60 Hz, but this could be 220V/60 Hz instead. In some cases, the power extension apparatus 100 could support multiple power distribution specifications. Each power extension apparatus 100 could further contain a fuse and a circuit breaker for surge protection. It shall be noted that the focus of the present invention is not on the electricity distribution specifications nor the power protection, but the capability to create a power-line based local area network using the existing power line wiring, replacing the conventional network hub and a large number of network cables.

It shall be noted that the physical layer (PHY) is not limited to a specific specification such as RJ-45, or a specific transmission speed. Any appropriate cable connection specification such as fiber optics, or any appropriate transmission speed such as 10, 100, or 1000 Mbps could all be supported.

The network interface ports 124 on the same power extension apparatus 100 need not be the same type, for example, some use RJ-45 Ethernet cable connectors, while others may be fiber optic cable connectors.

All network interface ports 124 are connected to a network module 130 embedded in the casing 120, whose functions and technical specifications are similar to that of a conventional network hub or switch.

The network module 130 is able to support general network functions such as auto sensing, flow control, full/half duplex etc, and more advanced functions such as virtual LAN (VLAN), and load-balancing.

Since the techniques involved in a network hub or switch have already been quite well known to people in the related art, the details about the network module 130 is omitted here for simplicity sake.

Through the function of the network module 130, all computing devices being connected to the same power extension apparatus 100 or separate power extension apparatuses, as individual nodes, can transmitted video, audio, text, and control signals among the nodes of the power-line network.

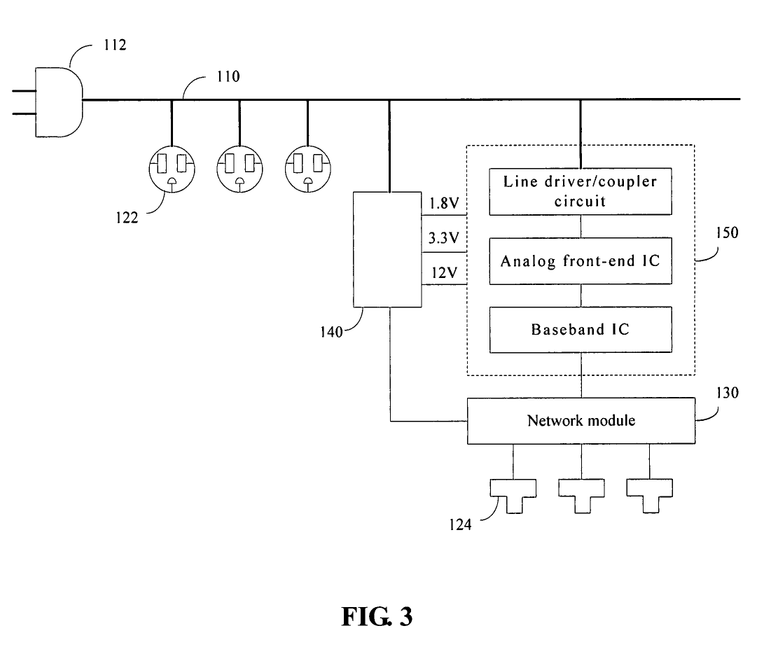

Referring to FIG. 3, the architecture of the casing 120 of the power extension apparatus 100 also includes a power module 140, whose function is to convert the input AC to +1.8V/3.3V/12V DC for driving the network module 130 and the conversion module 150.

The architecture of the conversion module 150 is similar to a conventional power-line adaptor such as a HomePlug adaptor. The conversion module 150 is simultaneously connected to the network module 130 and extension cable 110, through which data packets are first received from the network cable and modulated onto the AC waveform and then transmitted over the extension cable 110 compliant with an appropriate power-line communication protocol, and also vice versa.

A number of chipsets for implementing the conversion module 150 are currently available from various vendors. For example, the conversion module 150 could be formed by an INT5500 baseband IC and an INT1200 analog front-end IC, both by Intellon, and a line driver and a driver/coupler, as shown in FIG. 3. The conversion module 150 so created can support HomePlug 1.0 Turbo mode whose speed is up to 85 Mbps.

The details of these chipsets and how they are integrated could be obtained from the technical documentation publicly published by relevant vendors. They are therefore omitted here.

The main focus of the present invention is not in the implementation details of the network module 130 or the conversion module 150. It lies in the integration of commonly known technologies in a novel manner so as to achieve unexpected function from an ordinary power extension cable

The power extension apparatus 100 is also a regular power extension cord for distributing power to multiple computing devices being connected thereon.

Depending on how the conversion module 150 is implemented, the conversion module 150 in accordance with the present embodiment is able to support different versions of HomePlug standards, such as HomePlug 1.0 Standard, HomePlug 1.0 Turbo mode, and HomePlug AV.

HomePlug 1.0 Standard provides 14 Mbps transmission rate, while HomePlug AV is an enhanced version that is able to provide 200 Mbps transmission rate for real time audio and video.

The power extension apparatus 100 could further contain indicator lights 126 that reflect the line status, network connectivity, and data flow activities.

The power extension apparatus 100 could contain an optional testing function to detect the presence of other computing devices also connected to the power line wiring and cable of data communications with the present embodiment. The power extension apparatus 100 has a triggering device, such as a press button 128, on the surface panel of the casing 120 connected to the conversion module. When depressed, the conversion module 150 is triggered to conduct the line testing function, and the results are reflected on the indicator lights 126 accordingly. This function allows a user to check the network connectivity and search for other compliant computing devices, even without using any special tools.

In accordance with the present invention, the power extension apparatus 100 is not only compatible with all current versions of the HomePlug standard, but would also could support future specifications of the HomePlug standard.

The compatibility of the present invention is not limited to the HomePlug standards. In accordance with the present invention, the spirit of the present invention shall be extended to other power line communication protocols and network media that use the AC power waveform as carrier and the power lines to transmit data signals.

Although the present invention has been described with reference to the preferred embodiments thereof, it is apparent to those skilled in the art that a variety of modifications and changes may be made with regard to different forms and shapes without departing from the spirit and scope of the present invention which is intended to be defined by the appended claims.

What is claimed is:

1. A power extension apparatus, comprising:
an extension cable of appropriate length that is attached with a power plug on one end for electrically connecting to a power line wiring;
a casing being connected to another end of the extension cable, having a plurality of power sockets and network interface ports on the surface panel, where the power sockets provide power to two or more computing devices from the power line wiring that conforms to a power distribution specification;
a network module that is embedded in the casing and electrically connected to all network interface ports, providing at least one of the functions of a network hub and a switch;
a conversion module being connected to the extension cable and the network module, where the conversion module is to convert data packets from the network module and to modulate the converted signals onto the AC power waveform to be transmitted through the power line wiring to other computing devices compliant with an appropriate data communication protocol, and also vice versa; and
a power module being connected to the extension cable, through which input AC is converted to appropriate DC output to provide operating power for driving the network module and the conversion module;
wherein
two or more computing devices connected to the same power extension apparatus via the network interface ports are able to communicate with each other via the network module; and
a computing device connected to the power extension apparatus via the network interface ports is able to communicate with another computing device connected to the power line wiring and supporting the appropriate data communication protocol.

2. The power extension apparatus as claimed in claim 1, wherein the network interface ports are RJ-45 ports.

3. The power extension apparatus as claimed in claim 1, wherein the appropriate data communication protocol is one of the HomePlug standards.

4. The power extension apparatus as claimed in claim 1, wherein the casing has at least an indicator light on the surface panel for indicating operating status of the power extension apparatus.

5. The power extension apparatus as claimed in claim 1, wherein the power extension apparatus has a triggering device on the surface panel of the power extension apparatus connected to the conversion module; and the triggering device, once activated, causes the power extension apparatus to detect the presence of any computing device connected on the power line wiring and supporting the appropriate data communication protocol.

6. The power extension apparatus as claimed in claim 5, wherein the triggering device is a press button.
